(19) United States
(12) Patent Application Publication
(10) Pub. No.: US 2009/0254832 A1
(43) Pub. Date: Oct. 8, 2009

(54) Method and Apparatus for Collaborative Design of an Avatar or Other Graphical Structure

(75) Inventors: Renxiang Li, Lake Zurich, IL (US); Jingjing Meng, Evanston, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 12/061,743

(22) Filed: Apr. 3, 2008

(51) Int. Cl. G06F 15/177

(52) U.S. Cl. 715/734

(57) ABSTRACT

A method and apparatus for collaborative design of a graphical structure is by users of a network. First, a description of the graphical structure is downloaded from a network server to client devices of the users. User modifications of the graphical structure are then uploaded to the network sever from the client devices. The modifications from multiple users are aggregated to produce an aggregated modification, which is then used to update the graphical structure. A description of the modifications may be a text-based description, in which case it is mapped to a numerical description of the modifications. Alternatively, the descriptions of the modifications may be numerical values. The modifications from a plurality of users (received during a specified time period) may be aggregated by calculating a statistical measure of numerical values corresponding to the modifications. The graphical structure may be an avatar, for example.

### BACKGROUND

An avatar is a graphical representation of a person, such as a network user, or a group of people, such as a network community. Additionally, an avatar may be a graphical personification of a computer or an organization. An avatar may be, for example, an image, a cartoon character, or an icon. An avatar may be two dimensional or three dimensional and may be animated.

Software applications are available that allow a computer user to create and modify avatars, or other graphical material, using a graphical user interface. An avatar may be represented by a number of parameters that act upon a baseline graphical structure, which include geometry data, texture data, animation data and other graphical elements, to define the appearance and behavior of an avatar. These parameters, which are input or adjusted by a user, are used by a rendering program to produce an image or rendering of the avatar.

Additionally, it is known that an image of a face may be generated by combining elemental features. The elemental features may be eyes, lips, nose, hair etc., as in photo-composition pictures where the face of a suspect is constructed from eyewitness descriptions. Alternatively, the elemental features may be principal components obtained by analyzing multiple faces. It is also known that different faces or other images can be combined by morphing techniques.

Virtual Whiteboards allow multiple network users view and add content to a two-dimensional graphical image.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram of a system for collaborative design of a graphical structure in accordance with some embodiments of the invention.

FIG. 2 is a flow chart of a client method for collaborative design of a graphical structure in accordance with some embodiments of the invention.

FIG. 3 is a flow chart of a server method for collaborative design of a graphical structure in accordance with some embodiments of the invention.

FIG. 4 is a diagrammatic representation of the server side of a system for collaborative update of a graphical structure in accordance with some embodiments of the invention.

FIG. 5 shows a mapping module for mapping a text-based modification input into a numeric modification vector, in accordance with some embodiments of the invention.

FIG. 6 is a diagrammatic representation of a client-side system for collaborative update of an avatar or other graphical structure in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to the collaborative creation of avatars or other graphical structure. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may comprise one or more conventional processors and unique stored program instructions that control the one or more processors to implement, in conjunction with certain non-processor circuits, some, most, or all of the functions relating to the collaborative creation of avatars or other graphical structures described herein. The non-processor circuits may include, but are not limited to, a radio receiver, a radio transmitter, signal drivers, clock circuits, power source circuits, and user input devices. As such, these functions may be interpreted as a method to perform the collaborative creation of avatars or other graphical structures using a network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates to collaborative generation of avatars or other graphical structures by network users.

For example, the network users may be a group or artists or designers at different physical locations that wish to collaborate in creating a graphical structure.

In another example, the network users may be participants in a particular on-line community. Even though the users may be diverse in terms of age, gender, culture, occupation, etc., they share a common interest in that community—something that ties them together. One way to manifest the common preference of a community visually is through the collaborative creation of a community avatar.

In one embodiment of the invention, a graphical structure is collaboratively designed by users of a network. First, a baseline description of the graphical structure is downloaded from a network server to client devices of the users. Descriptions of user modifications of the graphical structure are then uploaded to the network sever from the client devices. The descriptions of the modifications from multiple users are aggregated to produce a description of an aggregated modification, which is then used to update the description of the graphical structure, generating a new baseline graphical structure.

The description of the modifications to the graphical structure may be a text-based description, in which case the text-based description of the modifications is mapped to a numerical description of the modifications. Alternatively, the descriptions of the modifications may be numerical values. The descriptions of the modifications from a plurality of users (received during a specified time period) may be aggregated by calculating a statistical measure of numerical values corresponding to the modifications.

Previous systems, such as virtual whiteboards, do not aggregate user inputs and do not parameterize the image. In addition, they do not provide the mapping of text-based descriptions to numerical parameter values.

The description of the graphical structure may be a geometrical or numerical representation, from which an image of the graphical structure may be rendered. Alternatively, the description of the graphical structure may be a rendered image of the graphical structure.

The design is iterative, so the elements may be repeated until the aggregated modifications to the graphical structure become smaller than a threshold or until a decision is made to end the modification.

One embodiment of a corresponding system for collaborative design of a graphical structure by users of a network includes at least one of a network server and a client device connected by a network. The network server includes a memory for storing the baseline graphical structure and an associated parameter vector that specifies the modification to the graphical structure or controls elements of the graphical structure, an input for receiving, via the network, modifications to the graphical structure specified by the users of the network and a number of parameter aggregation modules for aggregating parameter modification vectors from multiple users. The network server also includes an update module for updating the parameter vector in accordance with the aggregated parameter modification vector and an output for sending a description of the updated graphical structure and/or the updated parameter vector to users of the network. The updated parameter vector, along with the baseline graphical structure that users have previously downloaded from the server, specifies an updated graphical structure.

The client device may include an input for downloading a description of the baseline and updated graphical structures, and/or the updated parameter vector from a network server, a display for displaying an image of the graphical structure derived from the description of a graphical structure, an interface that enables a user of the client to specify modifications to the graphical structure; and an output for uploading modifications to the graphical structure to the network server.

A modification to the graphical structure specified by a user of the network may be a text-based description, in which case the network server also includes a mapping module that receives the text-based description as input and produces a numerical parameter modification vectors as output. Alternatively, the modification to the graphical structure specified by a user of the network may be a vector of numerical parameters or a vector of numerical parameter changes.

The description of the updated graphical structure may be a vector of numerical parameters, in which case the client device also includes a rendering module that produces an image of the graphical structure dependent upon the baseline graphical structure and the associated vector of numerical parameters. Alternatively, the description of the updated graphical structure may be a rendered image of the graphical structure.

By way of example, the invention is described below in terms of collaborative design of an avatar. However, it is to be understood that other graphical structures may be designed using the method and apparatus described or their equivalents.

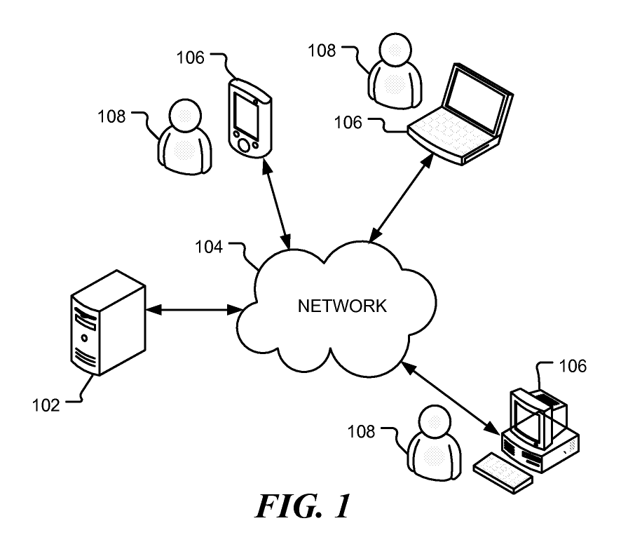

FIG. 1 is a diagram of a system for collaborative design of an avatar (or other graphical structure). A model of the avatar is stored on a network server 102 that is connected via network 104 to a number of client devices 106 of users 108. The avatar may be a virtual character defined by the baseline graphical structure together with a vector of numeric control parameters, such as “face length”, “skin color”, “hair color”, “hair style”, etc. The baseline graphical structure, the vector of numeric control parameters and associated rendering rules provide a model of the avatar. The network users 108 may view the avatar on their client devices 106 by downloading the baseline graphical structure and the parameters from the server 102 and rendering the avatar locally. Alternatively, a snapshot (an example image) of the avatar may be rendered by the network server 102 and the users 108 may download the rendered image from the network server 102. Still further, the network users may store parameters locally and download changes to the parameters from the network server 102. All of these processes will be referred to as “downloading a snapshot of the avatar”.

The networks users 108 upload suggested parameters changes to the network server 102. The parameters changes from multiple users are combined and used to update the avatar. The parameters may be collected over a selected time period, which may extend from several minutes to several weeks or longer. A snapshot of updated avatar may then be downloaded by the network users.

Optionally, parameters of the final stable avatar snapshot may be categorized (e.g. color, size, hair style, cloth style, etc) and associated with the characteristics of the virtual community, as a form of knowledge for the user group of the community.

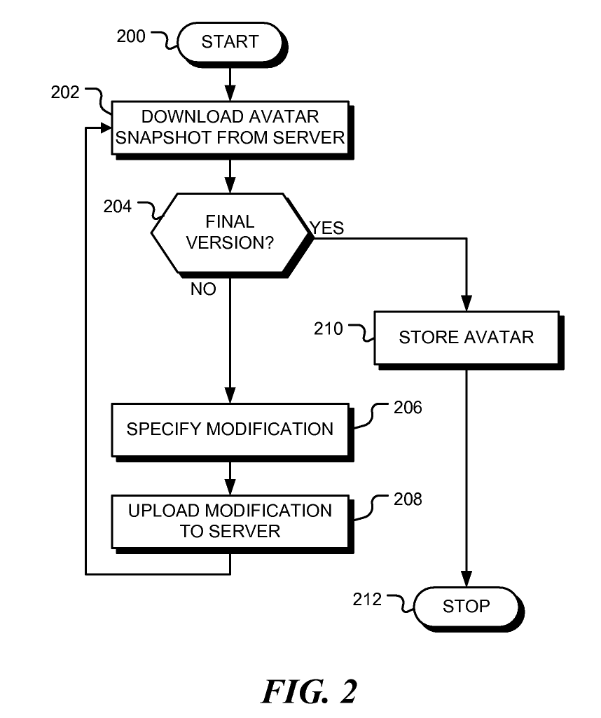

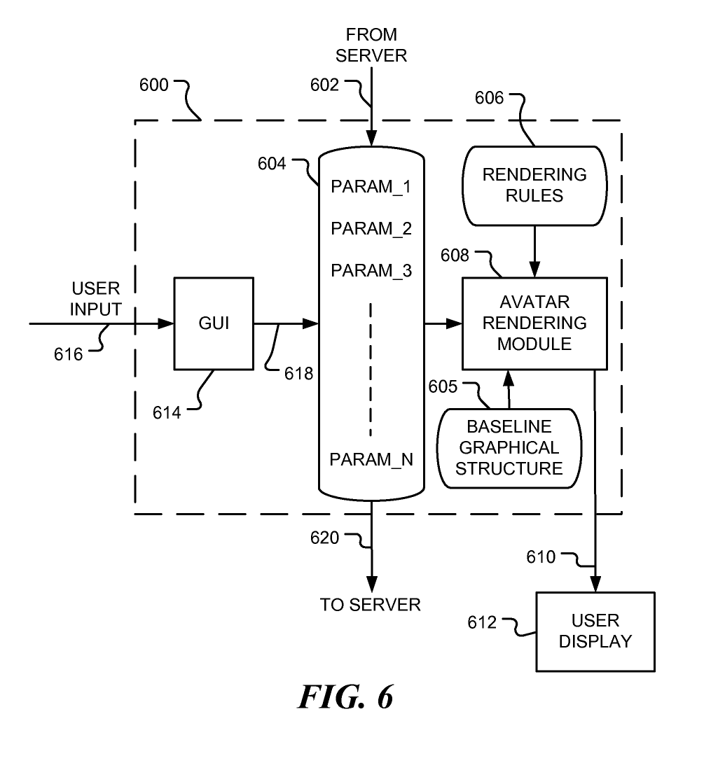

FIG. 2 is a flow chart of a client method for collaborative design of an avatar or other graphical structure. Following start block 200, a network user downloads, at block 202, a snapshot of the avatar being designed from the network server. If this is not the final version of the avatar, as depicted the negative branch from decision block 204, the user specifies modifications to the avatar at block 206. In one embodiment, the user performs a local modification to the avatar, using a graphical user interface for example, and then any parameters changes are uploaded to the network server at block 208. In a further embodiment, discussed below with reference to FIG. 6 the user may generate a textual description of desired modifications. The textual description may be uploaded to the server at block 208 and mapped into corresponding parameter changes at the server. Alternatively, the textual description may be mapped into corresponding parameter changes locally and the parameters changes uploaded to the network server at block 208. Once the final version of the avatar is obtained, as depicted by the positive branch from decision block 204, the avatar may be stored at block 210 and the process terminates at block 212. The decision to end modification of the avatar may be made by a moderator of the virtual community, or may be made automatically after a set time period or when aggregated changes to the avatar become sufficiently small.

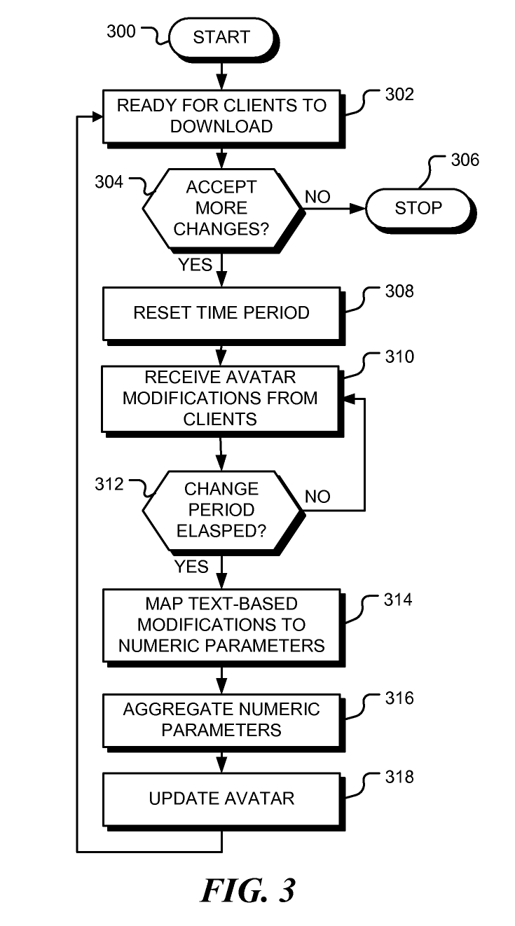

FIG. 3 is a flow chart of a server method for collaborative design of an avatar or other graphical structure. Following start block 300, the server makes an initial (baseline) or modified avatar ready for clients to download at block 302. The avatar may be downloaded in response to requests from clients. At decision block 304, the server determines if any changes to the avatar are to be accepted. This decision may be made automatically, by a system administrator or by a designated user, for example. If no more changes are to be accepted, as depicted by the negative branch from decision block 304, the process terminates at block 306. Otherwise, as depicted by the positive branch from decision block 304, the time period for accepting modifications is reset at block 308. At block 310, avatar modification requests are received from clients (users). While the time period for modifications has not elapsed, as depicted by the negative branch from decision block 312, the server continues to receive modification requests from clients. When the time period has elapsed, as depicted by the positive branch from decision block 312, the server maps any text-based modification requests to numeric parameters at block 314. At block 316, the numerical parameters corresponding to the modification requests from multiple users are aggregated. This may be done by calculating an average or median value of each parameter, for example. At block 318 the avatar model is updated and flow returns to block 302, where the updated avatar and/or the associated parameter vector are made available for uploading to clients (as a vector of new parameters, a list of parameter changes or a newly rendered snapshot, for example).

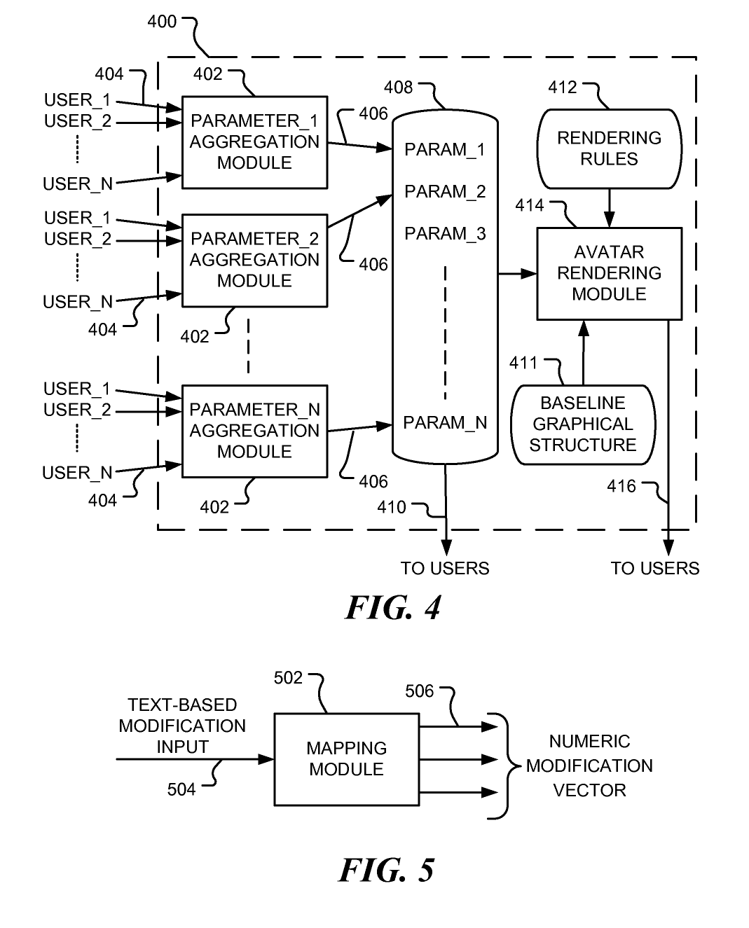

FIG. 4 is a diagrammatic representation of the server side of a system for collaborative update of an avatar or other graphical structure in accordance with some embodiments of the invention. The system 400 includes a number of parameter aggregation modules 402. Each module receives parameter inputs 404 from multiple remote users and determines an aggregate value 406 for the parameter. The aggregate value may be an average, for example. The aggregation process may be performed at specified time intervals. A parameter vector, stored in memory and update module 408, is updated using the aggregated parameters values. In one embodiment, the parameter aggregation modules 402 are implemented as software on the server. In an alternative embodiment, users may supply parameters change values 404 which are aggregated in aggregation modules 402 to generate aggregate parameter changes 406. The updated parameter vector 410 may be passed back to the users for further modification. Optionally, the parameter vector 410, the baseline graphical structure 411, and rendering rules 412 are used by avatar rendering module 414 to generate a snapshot 416 of the avatar, which may be passed back to the users for further modification. In this manner, the avatar is updated iteratively.

The user parameter aggregation process is a multiple-to-one mapping that maps multiple numerical inputs into a single numerical output, which is used to modify or define one feature of the avatar. Optionally, different user's input may be weighted. This aggregation process is done for every feature in the parameter vector. Various statistical measures, such as mean, median, or root-mean-square can be used for the mapping. Additionally, a threshold or other algorithms may be used to exclude statistical outliers or malicious user input.

In one embodiment, the server collects the input within a time period. The period could be in one minute or in one day or even one year. The parameters are then aggregated and used to update the avatar. A new snapshot is then released to the users. As the avatar gradually becomes stable, as evidenced by the variance of the input modification parameters, the moderator of the community can declare that a stable version has been achieved and the avatar snapshot will no longer be modified.

The server can maintain a history of each individual user's numeric delta input, so that the server always has a record of those individuals that contributed to a particular modification. Based on this information, a dedicated set of parameter changes can be generated for each individual user. This enables the user to generate the updated avatar snapshot at the client side, using their locally modified avatar and the parameters changes. Alternatively, the parameter changes relative to the previously uploaded avatar snapshot can be made available to all users.

FIG. 5 shows a mapping module 502 for mapping a text-based modification input 504 into a numeric modification vector 506 containing modifications to one or more parameters. For example, in one embodiment, if the text-based input includes the text “make the nose larger”, the mapping module will identify keywords “nose” and “larger” and interpret the input as a request to increment the parameter defining size of the avatar's nose by some numeric value. The corresponding numeric value of the increment will be output. This increment will be aggregated with other requested increments from other users, as described above.

The process described above enables a virtual community to define collaboratively an avatar that a majority of the participants are satisfied with. The process is iterative and aggregates input from multiple users. Additionally, a mapping process is used to translate text-based modification description into a numerical modification vector. The process may be used to define graphical structures other than avatars.

In one embodiment of the invention, a user may want to collaborate in the design of a graphical structure by downloading an initial description of the graphical structure (the baseline) from a network server to a client device of the user, specifying a modification to the graphical structure and uploading a description of modification to the network sever from the client device. The network server aggregates modifications from multiple users and updates the description of the graphical structure. The user may then download an updated description of the graphical structure or a description of the aggregated modification from the network server to his or her client device.

The user displays a rendered image of the graphical structure on the client device; and modifies the rendered image using a tool with a graphical user interface.

The description of the modifications to the graphical structure may be a text-based description, a vector of changes to numerical values of parameters that define the graphical structure, or the actual numerical values of parameters that define the modified graphical structure.

FIG. 6 is a diagrammatic representation of a client-side system 600 for collaborative update of an avatar or other graphical structure in accordance with some embodiments of the invention. The client device may be, for example, a computer or a mobile device, such as a mobile telephone, Personal Digital Assistant (PDA), portable computer, or other networked device. The system 600 downloads a parameter vector 602 from a network server and uses it to update a stored parameter vector 604. The parameter vector 602 may specify actual parameter values or changes to previous parameter values. The parameter vector 604 and baseline graphical structure 605 and rendering rules 606 are used by avatar rendering module 608 to generate a snapshot 610 of the avatar. The snapshot is displayed on user display 612. A graphical user interface (GUI) 614 receives user input 616 and generates parameter updates 618. These updates are used to update the parameter vector 604 and the associated avatar snapshot 610. The updated parameter vector (or the changes made to the vector) 620 are uploaded to the server. The updates may be sent at selected time intervals or when directed by the user. In this manner, the user updates the local avatar and contributes to the iterative modification of the community avatar.

It will be apparent to those of ordinary skill in the art that some embodiments of the invention may utilize existing technology elements. For example, existing networks such as the Internet may be used in addition to commonly used authoring tools for 2-dimensional or 3-dimensional graphics. Additionally, a dedicated avatar modification interface, which works as plug-in components for more general other authoring tools, can be used for avatar modification on client devices. These tools may be modified, or new applications may be written, to enable the communication of parameters over the network and the update of avatar snapshots.

The client device may be a mobile telephone equipped with Graphics Processing Unit (GPU). As such devices become more widely used, it is expected many users will join a virtual community and use their cell phone to interact with other participants in the virtual space. The ability to contribute to the creation of a community avatar may strengthen a user's bond with the community

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for collaborative design of a graphical structure by users of a network, the method comprising:
downloading a description of the graphical structure from a network server to client devices of the users;
uploading descriptions of user modifications of the graphical structure to the network sever from the client devices;
aggregating the descriptions of the modifications from a plurality of users to produce a description of an aggregated modification; and
updating the description of the graphical structure.

2. A method in accordance with claim 1, wherein a description of the modifications to the graphical structure comprises a text-based description, the method further comprising mapping the text-based description of the modifications to a numerical description of the modifications.

3. A method in accordance with claim 1, wherein the descriptions of the modifications comprise numerical values and wherein aggregating the descriptions of the modifications from a plurality of users comprises calculating a statistical measure of numerical values corresponding to the modifications.

4. A method in accordance with claim 1, wherein the aggregation process comprises weighting user modification dependent upon the user's identity.

5. A method in accordance with claim 1, wherein aggregating the descriptions of the modifications from a plurality of users comprises aggregating descriptions uploaded to the network server within a specified time period.

6. A method in accordance with claim 1, wherein the graphical structure comprises an avatar and wherein the users of the network are members of a virtual community.

7. A method in accordance with claim 1, wherein the description of the graphical structure comprises a baseline graphical structure and an associated parameter vector, from which an image of the graphical structure may be rendered.

8. A method in accordance with claim 1, wherein the description of the graphical structure comprises a rendered image of the graphical structure.

9. A method in accordance with claim 1, wherein the elements are repeated until the aggregated modifications to the graphical structure become smaller than a threshold.

10. A method in accordance with claim 1, wherein the elements are repeated until a moderator terminates the process.

11. A method for a user of a network to collaborate in the design of a graphical structure, the method comprising:
downloading an initial description of the graphical structure from a network server to a client device of the user;
specifying a modification to the graphical structure;
uploading a description of modification to the network sever from the client device; and
downloading an updated description of the graphical structure from the network server to the client device of the user, the update description being an aggregate of modifications requested by a plurality of users of the network.

12. A method in accordance with claim 11, further comprising repeating the elements:
specifying a modification to the graphical structure;
uploading a description of modification to the network sever from the client device; and
downloading an updated description of the graphical structure from the network server to the client device of the user.

13. A method in accordance with claim 11, wherein specifying modifications to the graphical structure comprises:
displaying a rendered image of the graphical structure on the client device; and
modifying the rendered image using a tool with a graphical user interface.

14. A method in accordance with claim 11, wherein the description of the modifications to the graphical structure comprises a text-based description.

15. A method in accordance with claim 11, wherein the description of the modifications to the graphical structure comprises changes to numerical values of parameters associated with a baseline graphical structure.

16. A method in accordance with claim 11, wherein the description of the modifications to the graphical structure comprises numerical values of parameters associated with a baseline graphical structure.

17. A system for collaborative design of a graphical structure by users of a network, the system comprising:
a network server having:
a memory that stores a baseline graphical structure and an associated parameter vector,
an input element that receives, via the network, modifications to the baseline graphical structure specified by the users of the network;
a plurality of parameter aggregation modules responsive to modifications specified by the users, wherein the plurality of parameter aggregation modules produce an aggregated parameter modification vector;
an update module that updates the parameter vector in accordance with the aggregated parameter modification vector, the updated parameter vector specifying an updated graphical structure; and
an output element that sends a description of the updated graphical structure to users of the network.

18. A system in accordance with claim 17, wherein a modification to the baseline graphical structure specified by a user of the network comprises a text-based description and wherein the network server further comprises:
a mapping module that receives the text-based description as input and produces a numerical parameter modification vector as output.

19. A system in accordance with claim 17, wherein a modification to the baseline graphical structure specified by a user of the network comprises a vector of numerical parameters.

20. A system in accordance with claim 17, wherein a modification to the baseline graphical structure specified by a user of the network comprises a vector of numerical parameter changes.

21. A system in accordance with claim 17, wherein the graphical structure comprises an avatar.

22. A system in accordance with claim 17, further comprising:
a client device having:
an input unit for downloading a description of a graphical structure from the network server;
a display for displaying an image of the graphical structure derived from the description of the graphical structure;
an interface that enables a user of the client to specify modifications to the graphical structure; and
an output unit for uploading modifications to the graphical structure to the network server.

23. A system in accordance with claim 22 wherein the description the updated graphical structure comprises a vector of numerical parameters and wherein the client device further comprises a rendering module that produces an image of the graphical structure dependent upon the vector of numerical parameters.

24. A system in accordance with claim 17, wherein the description the updated graphical structure comprises a rendered image of the graphical structure.
